(19) United States
(12) Patent Application Publication
(10) Pub. No.: US 2026/0070400 A1
(43) Pub. Date: Mar. 12, 2026

(54) MODULAR ELECTRIFIED AXLE SYSTEM

(71) Applicant: KB Powertrain Inc., Huntington Beach, CA (US)

(72) Inventor: Bradley Ketchel, Huntington Beach, CA (US)

(21) Appl. No.: 19/216,823

(22) Filed: May 23, 2025

Related U.S. Application Data
(60) Provisional application No. 63/692,143, filed on Sep. 8, 2024.
(60) Provisional application No. 63/692,140, filed on Sep. 8, 2024.

(51) Int. Cl. B60K 1/00; B60B 35/00; B60B 35/16; B60G 7/00

(52) U.S. Cl. CPC B60K 1/00; B60B 35/007; B60B 35/16; B60G 7/008; B60K 2001/001

(57) ABSTRACT

An electrified axle system of a vehicle includes a drive unit having a coaxial motor disposed in a housing, a plurality of interchangeable first axle arms configured to removably couple to a first end of the drive unit, and a plurality of interchangeable second axle arms configured to removably couple to a second end of the drive unit. The electrified axle system also includes a support element extending from the first axle arm to the second axle arm.

Additionally, the axle system includes a suspension interface element disposed on each of the first axle arm and the second axle arm, and the suspension interface element is configured to removably couple each of the first axle arm and the second axle arm to a suspension system of the vehicle.

### CROSS-REFERENCE TO RELATED APPLICATIONS

This application claims the benefit of U.S. Provisional Application No. 63/692,140, filed on Sep. 8, 2024, and U.S. Provisional Application No. 63/692,143, filed on Sep. 8, 2024. The entire disclosures of the above applications are incorporated herein by reference.

### FIELD

The present technology relates to a vehicle axle system and, more particularly, to a modular electrified axle system having structural support elements.

### INTRODUCTION

This section provides background information related to the present disclosure which is not necessarily prior art.

Axle systems used with commercial and industrial vehicles may be difficult to adapt and integrate across different vehicle classes. As a result, vehicle manufacturers often design and manufacture distinct axle systems for each vehicle class, resulting in increased production costs, complex inventory management, and limited flexibility in vehicle platform development. Issues relating to adaptability and integration across different vehicle classes further contribute to inefficient manufacturing processes and extended development cycles, resulting in higher overall costs passed on to end users. The development of class-specific axle systems provides an additional barrier with respect to widespread adoption of electrified powertrains in commercial vehicles, as implementation of electrified axle systems may require extensive engineering resources and unique validation processes to ensure the electrified axle systems meet performance, durability, and safety requirements.

Integration of electrified axle systems into existing electric, hybrid, and internal combustion engine (ICE) vehicles also can require significant modifications to existing vehicle systems, such as vehicle suspension systems, leading to increased complexity and higher costs during vehicle conversion and/or new platform development. Additional challenges relate to maintaining structural integrity while accommodating varying load requirements across different vehicle classes. As a result, electrified axle systems may be overengineered, inefficient, and unnecessarily heavy. A lack of standardization in electrified axle systems may also create compatibility issues with existing wheel-end components, making it even more difficult to implement advanced features such as central tire inflation systems and specialized gearing in military and industrial applications.

Manufacturing methods for electrified axle systems further complicate the advancement of electrified commercial vehicles. For example, single-material construction of electrified axle systems, while addressing issues relating to high-strength specifications, may result in heavy vehicle components relative to certain vehicle classes, thereby compromising performance and reducing efficiency. The challenge of maintaining structural integrity and supporting varying load requirements ranging from light commercial loads to heavy-duty loads may also lead to overbuilt axle systems that minimize benefits of electrification.

Accordingly, there is a continuing need for a modular electrified axle system that is compact, lightweight, cost-effective, and easily adaptable for use with a variety of vehicle types. Desirably, the modular electrified axle system can accommodate varying load requirements, support different existing suspension configurations, and integrate with existing wheel-end components while reducing manufacturing complexity and optimizing structural integrity and vehicle performance.

### SUMMARY

In concordance with the instant disclosure, a modular electrified axle system that is compact, lightweight, cost-effective, easily adaptable for use with a variety of vehicle types, and that can accommodate varying load requirements, support different existing suspension configurations, and integrate with existing wheel-end components while reducing manufacturing complexity and optimizing structural integrity and vehicle performance, has surprisingly been discovered. The present technology includes articles of manufacture, systems, and processes that relate to axle systems for vehicles, and, more particularly, to a modular electrified axle system having a drive unit and interchangeable axle arms configured to support a variety of vehicle classes while maintaining compatibility with existing vehicle suspension systems and wheel-end components.

In certain embodiments, an axle system of a vehicle includes a drive unit having a motor and a housing, a first axle arm coupled to a first end of the drive unit, a second axle arm coupled to a second end of the drive unit, and a support element extending from the first axle arm to the second axle arm.. The axle system may be an electrified axle system that may include a drive unit having a coaxial motor disposed in a housing, a plurality of interchangeable first axle arms configured to removably couple to a first end of the drive unit, and a plurality of interchangeable second axle arms configured to removably couple to a second end of the drive unit. The electrified axle system may include a support element extending from the first axle arm to the second axle arm. Additionally, the axle system may include a suspension interface element disposed on each of the first axle arm and the second axle arm, and the suspension interface element may be configured to removably couple each of the first axle arm and the second axle arm to a suspension system of the vehicle.

In certain embodiments, a method of implementing an axle system in a vehicle may include a first step of providing an axle system having a drive unit, a motor, a first interchangeable axle arm, a second interchangeable axle arm, and a support element. In a second step, a vehicle type of the vehicle in which the axle system will be implemented may be determined. A third step may include selecting the first interchangeable axle arm from a plurality of first interchangeable axle arms each having a distinct shape, size, and configuration and the second interchangeable axle arm from a plurality of second interchangeable axle arms each having a distinct shape, size, and configuration. A fourth step may include coupling the first interchangeable axle arm and the second interchangeable axle arm to the drive unit using a coupling mechanism. In a fifth step, a support element may be coupled to each of the first interchangeable axle arm and the second interchangeable axle arm. The axle system may be installed in the vehicle in a sixth step.

In certain embodiments, a modular axle system for a vehicle may include a drive unit having a coaxial motor and a housing. The drive unit may be fabricated using a high-strength aluminum and configured to support a load capacity ranging from 22,000 pounds for a Class 2b vehicle to 70,000 pounds for a Class 8 vehicle. A plurality of modular first and second axle arms may be removably attached to the drive unit, where each modular first and second axle arm may be configured to adapt to specific vehicle requirements of a vehicle type in Class 2b, Class 8, and any vehicle class therebetween by varying in length, material composition, and structural design. Each first and second axle arm of the plurality of modular first and second axle arms may be configured to couple to an existing vehicle suspension system while maintaining a common drive unit across different vehicle classes. The modular first and second axle arms may be fabricated using a material selected from a group consisting of a singular material, a hybrid material, a combination of materials, and high-strength castings. The material may be selected based on the load capacity of the vehicle. The modular first and second axle arms may be configured to integrate with wheel-end components of the vehicle. The wheel-end components may include one or more of a wheel hub, a seal, a bearing, a geared wheel end, and a central tire inflation system (CTIS). A flat plate design may be disposed on each of the modular first and second axle arms and configured to enable the drive unit to support the existing vehicle suspension system. The drive unit may include a mating bolt pattern disposed on the housing. The mating bolt pattern may be configured to load capacities from 22,000 pounds to 70,000. The modular first and second axle arms may be configured to couple to internal combustion engine (ICE) vehicles, hybrid vehicles, and electric vehicles. The coaxial motor of the drive unit may be configured to provide hybrid electric propulsion, and the axle system may maintain a common drive unit across vehicle classes while supporting varying axle arm configurations.

In certain embodiments, a method of adapting a vehicle with a modular axle system, includes a first step of providing a drive unit with a coaxial motor and a housing. The central drive unit may be constructed from high-strength aluminum and configured to support a load capacity ranging from 22,000 pound to 70,000 pounds. In a second step, a first axle arm and second axle arm may be selected from a plurality of modular first and second axle arms based on a vehicle class and load requirement of the vehicle. Next, the first axle arm and the second axle arm may be coupled to the drive unit, and the first axle arm and the second axle arm are couple to an existing suspension system of the vehicle. In another step, each of the first axle arm and the second axle arm may be integrated with wheel-end components of the vehicle including at least one of a hub, a seal, a bearing, and a central tire inflation system (CTIS).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic diagram of an axle system, according to one embodiment;

FIG. 2 is a schematic diagram of an axle system, according to one embodiment;

FIG. 3 is a top perspective view of an axle system, according to one embodiment;

FIG. 4 is an exploded top perspective view of an axle system, according to one embodiment;

FIG. 5 is a top perspective view of an axle system wherein the axle arms are removed from the drive unit, according to one embodiment;

FIG. 6 is a top perspective view of an axle system, according to one embodiment;

FIG. 7 is a perspective view of a section of an axle system including support elements, according to one embodiment;

FIG. 8 is an elevational view of a section of an axle system including support elements, according to one embodiment; and

FIG. 9 is a flow diagram illustrating a method of using an axle system, according to one embodiment.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the adaptability and performance of electrified vehicle axle systems by providing a modular axle system having core components configured for use across multiple vehicle classes, interchangeable axle arms, and reinforcing support elements. The axle system is configured for enhanced structural integrity and can support varying load capacities up to and exceeding 70,000 pounds. Additionally, the present technology enhances manufacturing efficiency and platform flexibility while maintaining compatibility with existing vehicle suspension systems and wheel-end components.

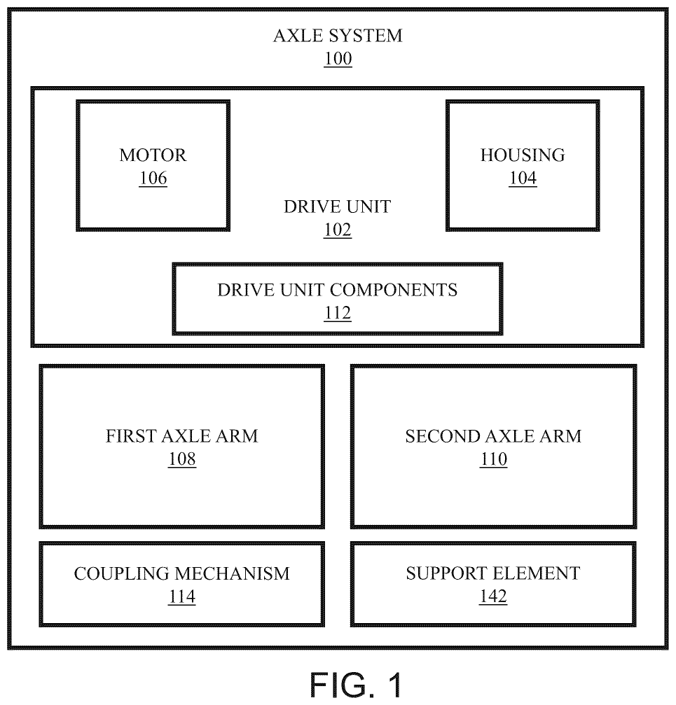

As shown in FIGS. 1-8, an axle system 100 may include a drive unit 102 having a housing 104 and a motor 106 disposed therein, a first axle arm 108, and a second axle arm 110. The drive unit 102 may be positioned centrally with respect to the first axle arm 108 and the second axle arm 110. In certain embodiments, the axle system 100 may be a modular electrified axle system 100 and the drive unit 102 may include a coaxial motor 106 configured to enhance power delivery and efficiency. It should be appreciated that the axle system 100 may include any suitable motor 106 and may be configured for use with electric, hybrid, and internal combustion engine (ICE) vehicles such as cars, trucks, military vehicles and the like. The drive unit 102 may include a gearbox, according to certain embodiments, as determined by a skilled artisan.

The drive unit 102 may include the housing 104, the motor 106, and additional drive unit components 112 such as power electronics disposed therein. The housing 104 may be configured to integrate with any number of drivetrain systems such as electric, hybrid, and gas powered. Any suitable high-strength material or materials may be used to fabricate the drive unit 102, as determined by a skilled artisan. In certain embodiments, the drive unit 102 may be fabricated using a strong, durable, and lightweight material, such as aluminum. The drive unit 102 may be configured to support load capacities up to and exceeding 80,000 pounds. In certain more particular embodiments, the drive unit 102 may be configured to support load capacities ranging from 22,000 pounds for Class 2b vehicles to 70,000 pounds for Class 8 vehicles.

Each of the first axle arm 108 and the second axle arm 110 may be removably coupled to the drive unit 102. In certain embodiments, the first axle arm 108 may be removably coupled to a first end 109 of the drive unit 102, and the second axle arm 110 may be removably coupled to a second end 111 of the drive unit 102 opposite the first end. The drive unit 102 may be disposed centrally with respect to the first axle arm 108 and the second axle arm 110. Each of the first axle arm 108 and the second axle arm 110 may be removably coupled to the drive unit 102 using a coupling mechanism 114.

The coupling mechanism 114 may be any suitable coupling mechanism 114 such as a mechanical fastener capable of securely coupling each of the first and second axle arms 108, 110 to the drive unit 102. In certain embodiments, the coupling mechanism 114 may include a plurality of bolts (not shown). The plurality of bolts may have external threads configured to be received by a plurality of first openings 116 disposed in the drive unit 102 and a plurality of corresponding second openings 118 disposed in each of the first and second axle arms 108, 110. In certain embodiments, each bolt may be received by an element (not shown) such as a nut configured to receive the bolt, and/or one or both of the first and second openings 118 may include internal threads (not shown) configured to receive the bolt. It should be appreciated that any suitable coupling mechanism 114 or combination of coupling mechanisms 114 capable of securing the first and second axle arms 108, 110 to the drive unit 102 may be employed, such as bolts, nuts, and studs.

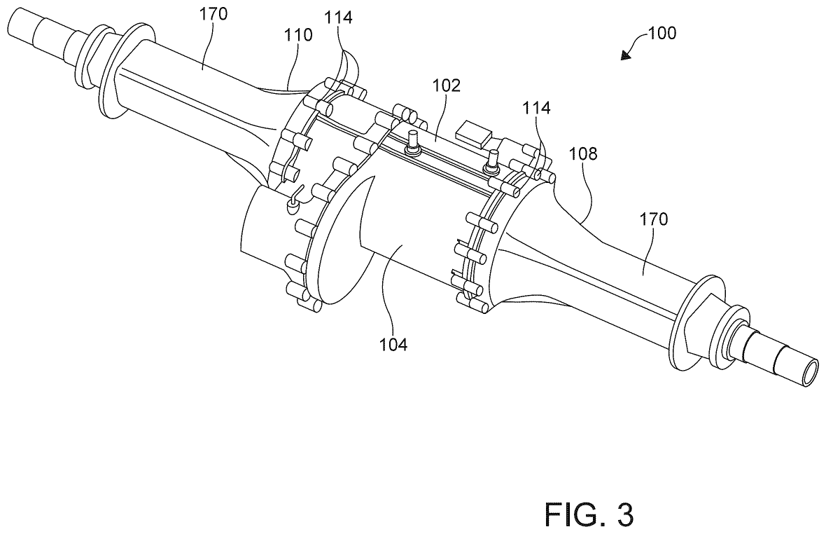

In certain embodiments, the coupling mechanism 114 may be a mating bolt pattern 120, as shown in FIGS. 3-6, including a plurality of first openings 116 disposed around a first drive unit perimeter 122 of the first end 109 of the drive unit 102 and a plurality of first openings 116 disposed around a second drive unit perimeter 124 of the second end 111 of the drive unit 102. The plurality of first openings 116 disposed around the first drive unit perimeter 122 may correspond with a plurality of second openings 118 disposed around a first axle arm perimeter 126 of a first end 128 of the first axle arm 108 and a plurality of second openings 118 disposed around a second axle arm perimeter 130 of a first end 132 of the second axle arm 110. The mating bolt pattern 120 may be configured to enable secure and precise coupling of the drive unit 102 to the first and second axle arms 108, 110 and enhance the structural integrity of the axle system 100 during operation.

In certain embodiments, the mating bolt pattern 120 may include between 2 and 8 first openings 116 disposed on a top portion 134 of the first drive unit perimeter 122, between 2 and 8 first openings 116 disposed on a bottom portion 136 of the first drive unit perimeter 122, between 2 and 8 first openings 116 disposed on a top portion 138 of the second drive unit perimeter 124, and between 2 and 8 first openings 116 disposed on a bottom portion 140 of the second drive unit perimeter 124. In another embodiment, the mating bolt pattern 120 may include between 4 and 6 first openings 116 disposed on the top portion 134 of the first drive unit perimeter 122, between 4 and 6 first openings 116 disposed on the bottom portion 136 of the first drive unit perimeter 122, between 4 and 6 first openings 116 disposed on the top portion 138 of the second drive unit perimeter 124, and between 4 and 6 first openings 116 disposed on the bottom portion 140 of the second drive unit perimeter 124. In a more particular embodiment, the mating bolt pattern 120 may include five first openings 116 disposed on the top portion 134 of the first drive unit perimeter 122, five first openings 116 disposed on the bottom portion 136 of the first drive unit perimeter 122, five first openings 116 disposed on the top portion 138 of the second drive unit perimeter 124, and five first openings 116 disposed on the bottom portion 140 of the second drive unit perimeter 124. It should be appreciated that, in certain embodiments, for every first opening 116 of the drive unit 102, there may be a corresponding second opening 118 on each of the first and second axle arms 108, 110.

The first and second axle arms 108, 110 may be fabricated using any strong, durable material or combination of materials. The shape, size and configuration of each of the first axle arm 108 and the second axle arm 110 may be any suitable shape, size, and configuration, as determined by a skilled artisan. The first axle arm 108 and the second axle arm 110 may be identical to one another, mirror images of one another, or distinct from one another. In certain embodiments, the first and second axle arms 108, 110 may be fabricated using singular materials, hybrid materials, and/or high-strength castings, depending on vehicle load and other vehicle and axle system 100 specifications. It should be appreciated that each of the first and second axle arms 108, 110 may be fabricated using any desirable material or combination of materials such as high-strength steel for heavy-duty applications, aluminum for weight-sensitive applications, and/or hybrid materials for optimal performance applications.

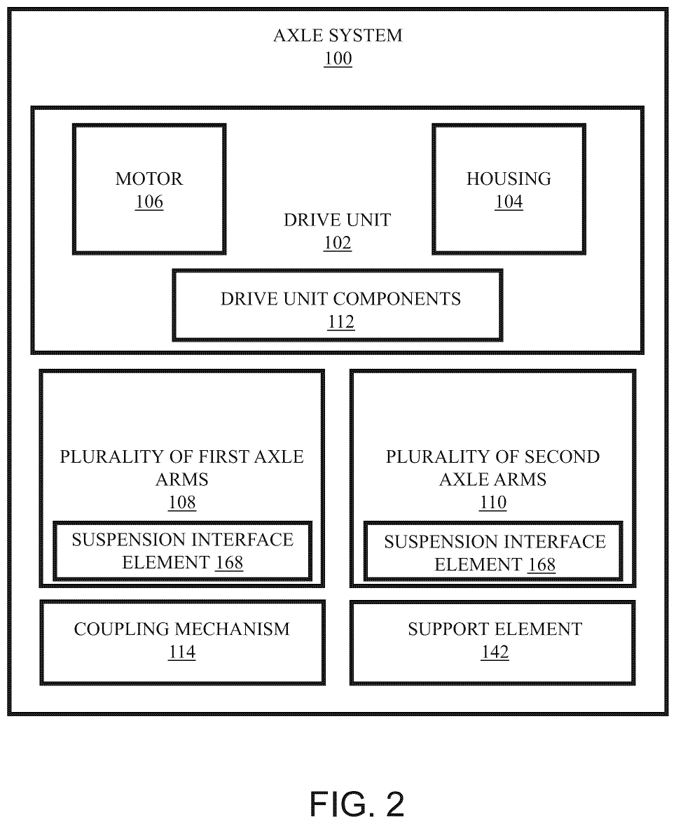

A variety of interchangeable first and second axle arms 108, 110 may be used in combination with the drive unit 102, as shown in FIG. 2. As such, the axle system 100 may be adapted for use with a wide range of vehicles such as trucks, SUVs, and vans in vehicle Class 2b and tractor-trailers, cement trucks, and dump trucks in vehicle Class 8, without modification of the drive unit 102. The variety of interchangeable first and second axle arms 108, 110 may include first and second axle arms 108, 110 having distinct shapes, sizes, lengths, and configurations, as well as variable structural specifications, while maintaining a standardized coupling mechanism 114 for removably coupling the first and second axle arms 108, 110 to the drive unit 102.

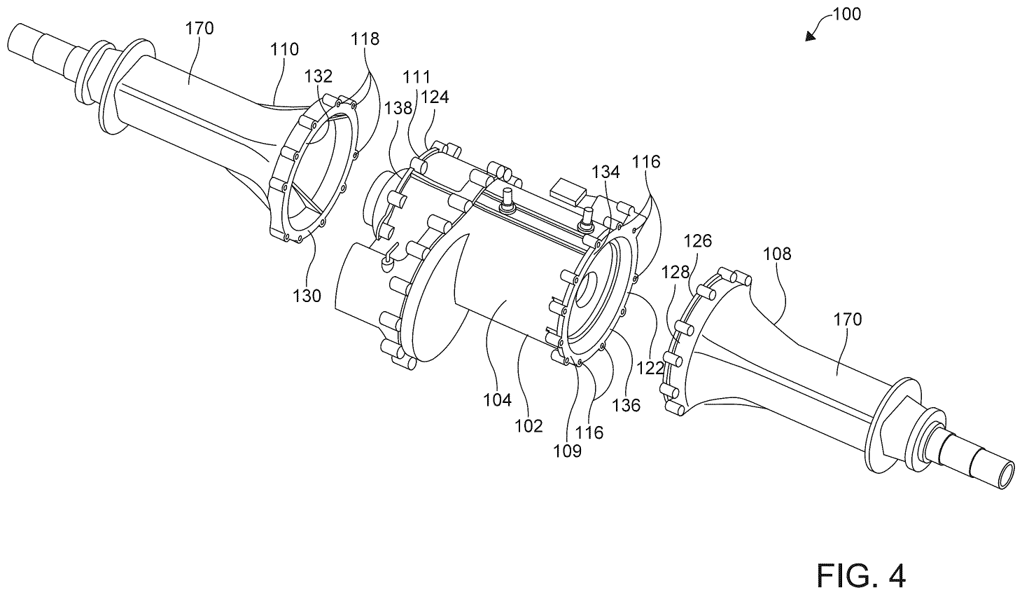

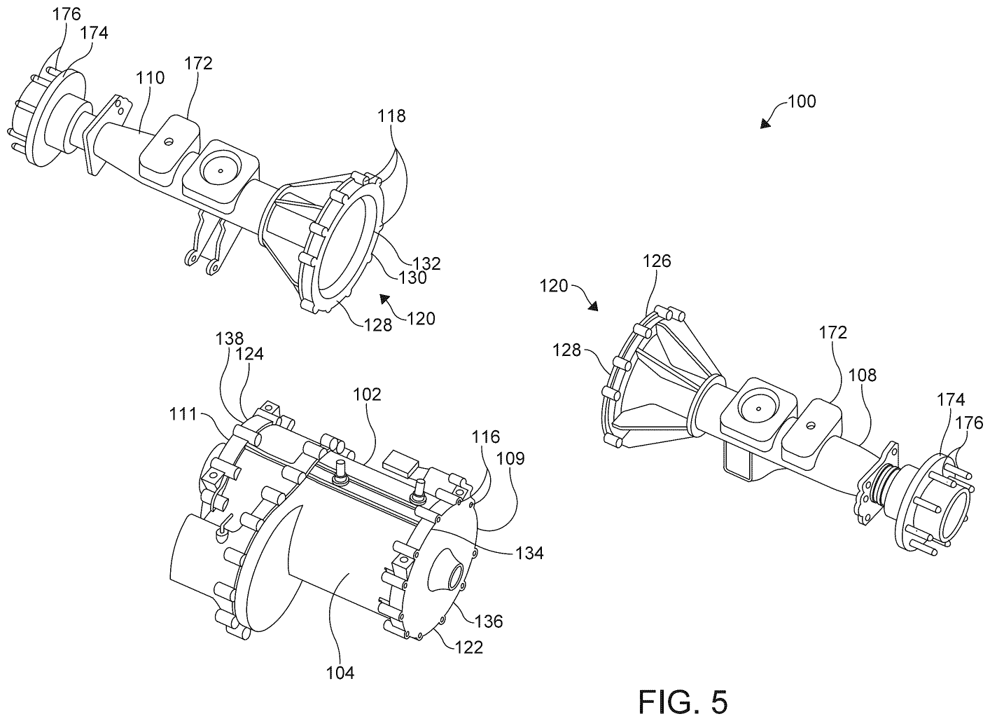

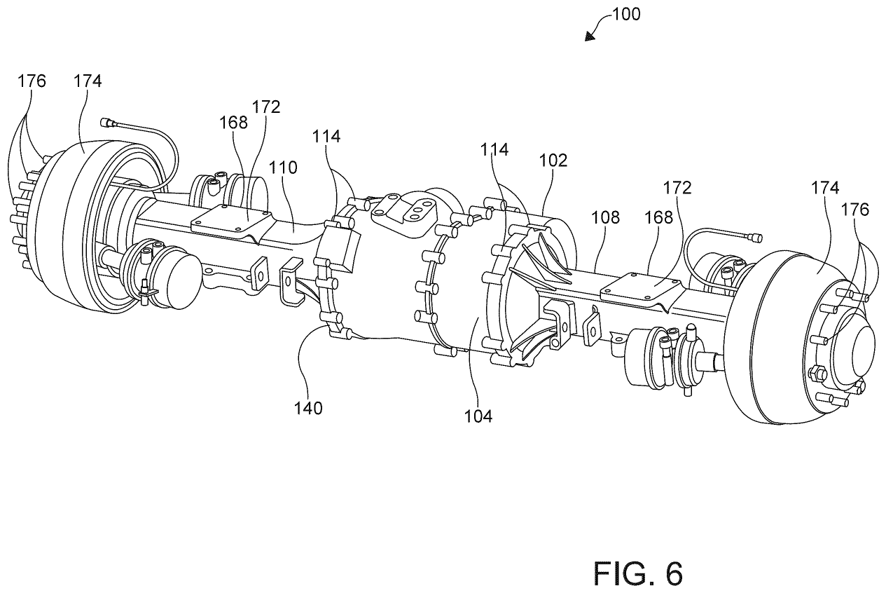

In certain embodiments, as shown in FIGS. 3 and 4, the first and second axle arms 108, 110 may include ductile iron and low alloy steel tubes suitable for vehicles in Class 3 and may be removably coupled to the drive unit 102 using the coupling mechanism 114. With reference now to FIG. 5, the first and second axle arms 108, 110 may be removably coupled to the drive unit 102 using the coupling mechanism 114, may be fabricated using ductile iron, and may have a shape, size, length, and configuration, as well as structural specifications suitable for vehicles in Class 6. As shown in FIG. 6, the first and second axle arms 108, 110 may be fabricated using ductile iron, may have a shape, size, length, and configuration, as well as structural specifications suitable for vehicles in Class 8, and may be removably coupled to the drive unit 102 using the coupling mechanism 114. It should be appreciated that each of the interchangeable first and second axle arms 108, 110 may have distinct shapes, sizes, lengths, configurations, and structural specifications required for integration with a desired vehicle in a desired vehicle class, as determined by a skilled artisan, while also being configured to couple to a common coupling mechanism 114 and a common drive unit 102.

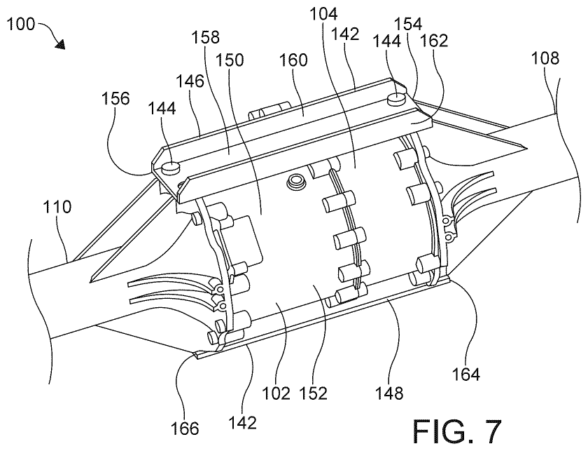

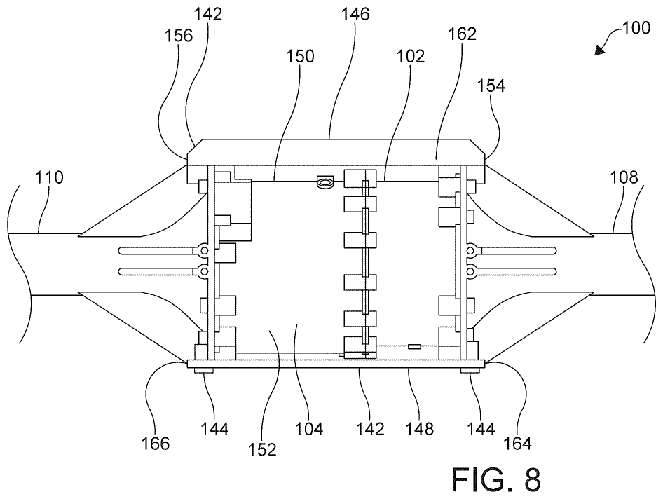

A support element 142, as shown in FIGS. 7 and 8, may be configured to couple the first axle arm 108 and the second axle arm 110 to one another and redistribute a vehicle load away from the drive unit 102. The support element 142 may be fabricated using any suitable high-strength, durable material or combination of materials such as carbon fiber, iron, steel, and/or aluminum, for examples. Any suitable connecting means 144 may be employed to permanently, semi-permanently, or removably couple the support element 142 to each of the first and second axle arms 108, 110, such as lug nuts and/or studs, as determined by a skilled artisan. In certain embodiments, the support element 142 may be configured to couple directly to each of the first and second axle arms 108, 110 but may not be coupled directly to the drive unit 102, thereby reducing the vehicle load on the drive unit 102. It should be appreciated that the support element 142 may be any desirable shape, size, and configuration capable of securely coupling the first and second axle arms 108, 110 to one another and militating against vehicle load stress of the drive unit 102.

The axle system 100 may include a first support element 146 and a second support element 148. In certain embodiments, the first support element 146 may be disposed adjacent a top end 150 of the drive unit 102 and the second support element 148 may be disposed adjacent a bottom end 152 of the axle system 100. In certain embodiments, a first end 154 of the first support element 146 may be coupled to the first axle arm 108 at the first end 128 of the first axle arm 108, and a second end 156 of the first support element 146 may be coupled to the second axle arm 110 at the first end 132 of the second axle arm 110.

The first support element 146 may have a base wall 158, a first side wall 160 extending upwardly from the base wall 158 and a second side wall 162 positioned opposite the first side wall 160 extending upwardly from the base wall 158. In certain embodiments, the first support element 146 may include one or more coupling components such as a ball-joint or bushing configured to be coupled to a suspension component of a vehicle suspension system such as a Panhard rod, a Vrod, or any other suspension component. The second support element 148 may be an element such as a skid plate configured to militate against damage to the drive unit 102 and enhance the structural integrity of the axle system 100. In certain embodiments, a first end 164 of the second support element 148 may be coupled to the first end 128 of the first axle arm 108 and a second end 166 of the second support element 148 may be coupled to the first end 132 of the second axle arm 110.

The axle system 100 may be configured to integrate with or couple to a vehicle suspension system using a suspension interface element 168. In certain embodiments, one or more suspension interface elements 168 may be disposed on or integral with one or both of the first axle arm 108 and the second axle arm 110 and may be configured to removably couple to one or more suspension components of the vehicle suspension system. It should be appreciated that the axle system 100 including the suspension interface element 168 may be configured to support any desired vehicle suspension systems such as beam and/or independent suspensions. In certain embodiments, the suspension interface element 168 may include a flat surface 170, as shown in FIGS. 3 and 4, or may be a flat plate 172, as shown in FIGS. 5 and 6, configured to removably couple to a vehicle suspension system.

The axle system 100 may include additional interface components, such as a wheel-end interface component 174. The wheel-end interface component 174 may be configured to secure each of the first and second axle arms 108, 110 to a vehicle wheel using a wheel-end mounting mechanism 176. In certain embodiments, the wheel-end interface component 174 may be configured to couple to any desired vehicle wheel component such as a hub, seal, bearing, and/or other specialized component such as a geared wheel end. Any suitable wheel-end mounting mechanism 176 may be used such as one or more lug nuts and/or studs, for example, as determined by a skilled artisan.

In certain embodiments, the axle system 100 may be configured to be coupled to or otherwise in communication with a central tire inflation system (CTIS) of a vehicle such as a military or industrial vehicle. It should be appreciated that, in certain embodiments, one or more components of the CTIS may be disposed in, coupled to, and/or otherwise in communication with the first axle arm 108 and/or the second axle arm 110. It should be further appreciated that, in certain embodiments, the CTIS may not be directly coupled to or disposed in the axle system 100 and may be independently housed in whole or in part in the vehicle wheel.

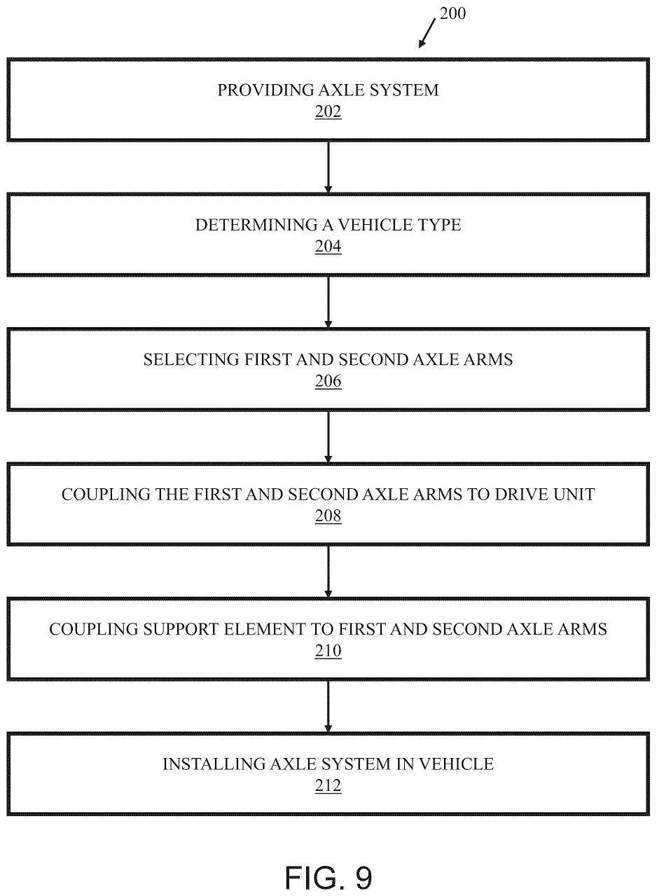

Referring now to FIG. 9, a method 200 of implementing an axle system 100, as described with reference to the embodiments presented herein, may include a first step 202 of providing the axle system 100 having a drive unit 102, a housing 104, a motor 106, a first interchangeable axle arm 108, a second interchangeable axle arm 110, and a support element 146. A second step 204 may include determining a vehicle type of the vehicle in which the axle system 100 may be implemented. Next, in a third step 206, the first interchangeable axle arm 108 may be selected from a plurality of first interchangeable axle arms, each having a distinct shape, size, and configuration and the second interchangeable axle arm 110 from a plurality of second interchangeable axle arms each having a distinct shape, size, and configuration. The first and second axle arms 108, 110 may be selected based on vehicle load requirements and any other suitable vehicle specifications, as determined by a skilled artisan. A fourth step 208 may include coupling the first and second axle arms 108, 110 to the drive unit 102 using a coupling mechanism 114. In a fifth step 210, one or more support elements 142 may be coupled to the first and second axle arms 108, 110. A sixth step 212 may include installing the axle system 100 in the vehicle. It should be appreciated that installation of the axle system 100 in the vehicle may include additional steps such as coupling the axle system 100 to an existing suspension system of the vehicle and coupling the axle system 100 to a wheel-end components of the vehicle.

It should be further appreciated that any number of steps relating to implementing and/or operating the axle system 100 100 may be included in the method 200. Steps may be repeated, omitted, and/or performed concurrently or sequentially. The order of the steps may be changed, as determined by one of skill in the art. It should be appreciated that the system 100 and method 200 may be adapted for use in various applications.

Additional steps relating to formation and manufacturing of the axle system 100 and/or the coupling of various components of the axle system 100, as well as steps relating to installation of the axle system 100 in the vehicle may also be included in the method 200, according to certain embodiments. For example, in certain embodiments, steps relating to precision machining, quality control measures, production of the axle system 100, and selection of materials and/or components based on vehicle type, load requirements, weight targets, cost, and existing vehicle systems may be included. Steps relating to formation of various components of the axle system 100 may be included such as steps relating to casting, forging, or composite layup depending on selected materials. Additional steps such as selecting the one or more support elements 142 based on vehicle load requirements, for example. may be included in the method 200. Selection of the one or more support elements 142 may also include evaluation of the materials and configurations of support elements 142. Steps relating to installation of a coaxial motor 106, as an example, in the housing 104 of the drive unit 102 may be included. Additionally, steps relating to installation of the axle system 100 in the vehicle such as quality verification steps to confirm proper alignment, clearances, and any other suitable operational requirements may be included in the method 200, as determined by a skilled artisan.

Advantageously, the axle system 100 may include a versatile drive unit 102 that is lightweight, strong, durable, compact, and configured for use with interchangeable first and second axle arms 108, 110, thereby enabling adaptation of the axle system 100 across multiple vehicle classes while maintaining drive unit 102 commonality. The standardized coupling mechanism 114 may allow for easy and secure coupling of the drive unit 102 to a variety of first and second axle arms 108, 110 having distinct shapes, sizes, and configurations. The drive unit 102 and interchangeable first and second axle arms 108, 110 may reduce development and manufacturing complexity and costs while maintaining structural integrity across a wide range of vehicle load requirements and enhancing performance.

The modular design of the of the first and second axle arms 108, 110 including the suspension interface elements 168 may allow for easy integration with a wide range of vehicle types and existing vehicle suspension systems while maintaining drive unit 102 commonality. The suspension interface elements 168 may be configured to enable the axle system 100 to work in combination with diverse vehicle platform requirements and without modification to existing vehicle suspension systems. The support elements 142 may be configured to redistribute vertical, axial, and radial suspension load from the high-strength, interchangeable first and second axle arms 108, 110, thereby militating against increased stress on the drive unit 102 and enabling integration with existing vehicle suspension systems. Additionally, the additional interface components, such as the wheel-end interface components 174, allow for compatible coupling between the first and second axle arms 108, 110 and a variety of wheel-end components, thereby allowing the axle system 100 to be used in combination with different vehicle platforms.

Advantageously, the axle system 100 may be integrated with electric vehicles, hybrid vehicles, and internal combustion engine vehicles without extensive axle system 100 and/or vehicle system modifications. The modularity and adaptability of the axle system 100 may enhance the structural integrity of the axle system 100 across varying load requirements, improve performance, and accommodate a range of existing vehicle system configurations. The axle system 100 may enable cost-effective development and manufacturing by using a standardized drive unit 102, coupling mechanism 114, and wheel-end interface components 174, while enhancing overall performance of the vehicle.

### EXAMPLE

### Class 8 Heavy-Duty Electric Axle System Implementation

Example embodiments of the present technology are provided with reference to FIG. 6.

An axle system 100 including a drive unit 102, a first axle arm 108, and a second axle arm 110 may be configured for use with a Class 8 heavy-duty truck requiring a 70,000 pound maximum load requirement. The drive unit 102 may be a standardized drive unit 102 configured for use with a variety of first and second axle arms 108, 110. The drive unit 102 may be fabricated using a high-strength material or combination of materials and may include a housing 104 and a coaxial motor 106 disposed therein. A coupling mechanism 114 including a mating bolt pattern 120 may securely couple the drive unit 102 to each of the first and second axle arms 108, 110. The coupling mechanism 114 may be a standardized coupling mechanism 114 such that the drive unit 102 of the axle system 100 may be used in combination with a variety of first and second axle arms 108, 110 having different shapes, sizes, lengths, configurations, and related specifications, thereby allowing the drive unit 102 to be used in combination with a number of vehicles in different vehicle classes.

The first and second axle arms 108, 110 may also be configured to couple to the drive unit 102 using the standardized coupling mechanism 114 and may be selected to optimally handle the maximum load requirement while maintaining the structural integrity of the axle system 100. The first and second axle arms 108, 110 may be manufactured using high-strength ductile iron castings configured to withstand Class 8 maximum load requirements. The first and second axle arms 108, 110 may include one or more suspension interface elements 168 configured to couple to an existing vehicle suspension system. The suspension interface elements 168 may include a flat plate 172 disposed on the first axle arm 108 and a flat plate 172 disposed on the second axle arm 110. The axle system 100 may have standardized wheel-end interface components 174 disposed on each of the first and second axle arms 108, 110 and configured to couple to wheel-end components such as specialized wheel-end components, geared wheel ends, and a CTIS to meet the requirements of the Class 8 heavy-duty truck.

First and second support elements 146, 148 fabricated from high-strength steel may be configured to couple the first and second axle arms 108, 110 to one another adjacent a top end 150 of the drive unit 102 and adjacent a bottom end 152 of the drive unit 102, respectively. The second support element 148 may be a reinforced skid plate configured to militate against damage to the drive unit 102 during operation and contribute to the overall structural integrity of the axle system 100. The first support element 146 may include one or more coupling components configured to couple to a component of the suspension system of the heavy-duty truck. The first and second support elements 146, 148 may be configured to redistribute a vertical, axial, and/or radial suspension load, thereby militating against excessive stress on the drive unit 102 during operation. The axle system 100 may be configured to include the standardized drive unit 102 while adapting to Class 8 vehicle requirements through selection and configuration of modular components such as the first and second axle arms 108, 110 and/or the first and second support elements 146, 148.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An axle system of a vehicle, comprising:
a drive unit having a motor and a housing;
a first axle arm coupled to a first end of the drive unit;
a second axle arm coupled to a second end of the drive unit; and
a support element extending from the first axle arm to the second axle arm.

2. The axle system of claim 1, wherein the motor is a coaxial motor.

3. The axle system of claim 1, wherein each of the first axle arm and the second axle arm is removably coupled to the drive unit using a coupling mechanism.

4. The axle system of claim 3, wherein the coupling mechanism includes a mating bolt pattern.

5. The axle system of claim 4, wherein the mating bolt pattern includes five first openings disposed on a top portion of a first drive unit perimeter, five first openings disposed on a bottom portion of the first drive unit perimeter, five first openings disposed on a top portion of a second drive unit perimeter, and five first openings disposed on a bottom portion of the second drive unit perimeter.

6. The axle system of claim 1, wherein the support element directly couples the first axle arm to the second axle arm.

7. The axle system of claim 1, wherein a first support element is disposed adjacent a top end of the drive unit and a second support element is disposed adjacent a bottom end of the drive unit.

8. The axle system of claim 7, wherein the first support element includes a suspension coupling component configured to couple the first support element to a suspension system of the vehicle.

9. The axle system of claim 7, wherein the second support element is a skid plate.

10. The axle system of claim 1, wherein the axle system includes a suspension interface element disposed on each of the first axle arm and the second axle arm, the suspension interface element is configured to removably couple each of the first axle arm and the second axle arm to a suspension coupling component of a suspension system of the vehicle.

11. The axle system of claim 10, wherein the suspension interface element includes a flat plate.

12. The axle system of claim 1, wherein a wheel-end interface component is disposed on each of the first axle arm and the second axle arm, each wheel-end component configured to secure one of the first axle arm and second axle arm to a wheel-end of the vehicle.

13. An electrified axle system of a vehicle, comprising:
a drive unit having a coaxial motor disposed in a housing;
a plurality of interchangeable first axle arms configured to removably couple to a first end of the drive unit;
a plurality of interchangeable second axle arms configured to removably couple to a second end of the drive unit; and
a support element extending from the first axle arm to the second axle arm;
wherein:
the axle system includes a suspension interface element disposed on each of the first axle arms and the second axle arms, and
the suspension interface element is configured to removably couple each of the first axle arm and the second axle arm to a suspension system of the vehicle.

14. The electrified axle system of claim 13, wherein:
the plurality of interchangeable first axle arms includes at least a first interchangeable first axle arm having a first shape, size, and configuration and a second interchangeable first axle arm having a second shape, size, and configuration that is different than the first shape size and configuration, and
the plurality of interchangeable second axle arms includes at least a first interchangeable second axle arm having the first shape, size, and configuration and a second interchangeable second axle arm having the second shape, size, and configuration.

15. The electrified axle system of claim 13, wherein a first support element is disposed adjacent a top end of the drive unit and a second support element is disposed adjacent a bottom end of the drive unit.

16. The electrified axle system of claim 15, wherein the first support element includes a suspension coupling component configured to couple the first support element to the suspension system of the vehicle.

17. A method of implementing an axle system in a vehicle, comprising:
providing an axle system having a drive unit, a motor, a housing, a first interchangeable axle arm, a second interchangeable axle arm, and a support element;
determining a vehicle type of the vehicle in which the axle system will be implemented;
selecting the first interchangeable axle arm from a plurality of first interchangeable axle arms each having a distinct shape, size, and configuration and the second interchangeable axle arm from a plurality of second interchangeable axle arms each having a distinct shape, size, and configuration;
coupling the first interchangeable axle arm and the second interchangeable axle arm to the drive unit using a coupling mechanism;
coupling a support element to each of the first interchangeable axle arm and second interchangeable axle arm; and
installing the axle system in the vehicle.

18. The method of claim 17, wherein each of the first interchangeable axle arm and the second interchangeable axle arm is selected based on a vehicle load requirement of the vehicle.

19. The method of claim 17, wherein the step of installing the axle system in the vehicle includes coupling the axle system to an existing suspension system of the vehicle.

20. The method of claim 17, wherein the motor is a coaxial motor and the axle system is an electrified axle system.
